(19) United States
(12) Patent Application Publication
(10) Pub. No.: US 2025/0166217 A1
(43) Pub. Date: May 22, 2025

(54) APPARATUS

(71) Applicant: TOYOTA JIDOSHA KABUSHIKI KAISHA, Toyota-shi (JP)

(72) Inventors: Yasuyoshi Hatano, Nisshin-shi (JP); Daiki Yokoyama, Miyoshi-shi (JP); Yasuhiro Saito, Toyoake-shi (JP)

(73) Assignee: TOYOTA JIDOSHA KABUSHIKI KAISHA, Toyota-shi (JP)

(21) Appl. No.: 18/795,539

(22) Filed: Aug. 6, 2024

(30) Foreign Application Priority Data
Nov. 21, 2023 (JP) 2023-197144

(51) Int. Cl. G06T 7/70

(52) U.S. Cl. CPC G06T 7/70; G06T 2207/10028; G06T 2207/30252

(57) ABSTRACT

An apparatus includes: a point cloud data acquisition unit that acquires three-dimensional point cloud data including a point cloud of a target region having a region in which a component is not assembled in a predetermined plurality of steps among external shapes of the moving body; and a position information acquisition unit that acquires at least one of a position and a direction of the moving body by comparing the acquired three-dimensional point cloud data with reference point cloud data including a point cloud corresponding to the target region.

### CROSS-REFERENCE TO RELATED APPLICATION

This application claims priority to Japanese Patent Application No. 2023-197144 filed on Nov. 21, 2023, incorporated herein by reference in its entirety.

### BACKGROUND

### 1. Technical Field

The present disclosure relates to an apparatus.

### 2. Description of Related Art

Japanese Unexamined Patent Application Publication (Translation of PCT Application) No. 2017-538619 (JP 2017-538619 A) discloses a technique of causing a vehicle to travel autonomously or through remote control in a manufacturing process of the vehicle.

### SUMMARY

There is known a technique of acquiring a position and a direction of a mobile body such as a vehicle based on a comparison between three-dimensional point cloud data measured by a distance measurement device and reference point cloud data, in order to move the mobile body through autonomous control or remote control. When a component is assembled to a mobile body in a manufacturing process of the mobile body, the outer shape of the mobile body may change. There is a demand for a technique that can appropriately compare three-dimensional point cloud data and reference point cloud data regardless of such a change in the outer shape of the mobile body.

The present disclosure can be implemented in the following aspects.

One aspect of the present disclosure provides an apparatus. The apparatus includes: a point cloud data acquisition unit that acquires three-dimensional point cloud data including a point cloud of a target region having a region in which a component is not assembled in a plurality of predetermined processes, of an outer shape of a mobile body; and a position information acquisition unit that acquires at least one of a position and a direction of the mobile body by comparing the acquired three-dimensional point cloud data with reference point cloud data including a point cloud corresponding to the target region. According to this aspect, a comparison can be made between the three-dimensional point cloud data and the reference point cloud data according to the target region having a region in which a component is not assembled, and thus a comparison can be appropriately made between the three-dimensional point cloud data and the reference point cloud data, even when the outer shape of the mobile body changes with the assembly of a component to the mobile body.

In the above aspect, the target region may be a region with a predetermined reference height or less, of an outer shape of a vehicle as the mobile body; and the reference height in a first process may be higher than the reference height in a second process as a post process of the first process.

According to this aspect, the reference height can be lowered according to the assembly of a component to a vehicle as the mobile body, and a comparison can be made more appropriately between the three-dimensional point cloud data and the reference point cloud data.

In the above aspect, the three-dimensional point cloud data may be point cloud data of the target region.

According to this aspect, a comparison can be made more appropriately between the three-dimensional point cloud data and the reference point cloud data by using the point cloud data of the target region as the three-dimensional point cloud data.

In the above aspect, the three-dimensional point cloud data may be point cloud data obtained by removing a part of measurement point cloud data measured by a distance measurement device.

According to this aspect, the point cloud data of the target region can be used for comparison with the reference point cloud data, even when the measurement point cloud data include a point cloud of a region outside the target region, and a comparison can be made more appropriately.

In the above aspect, the reference point cloud data may be point cloud data corresponding to the target region.

According to this aspect, a comparison can be made more appropriately between the three-dimensional point cloud data and the reference point cloud data by using the point cloud data corresponding to the target region as the reference point cloud data.

Besides the form of the apparatus discussed above, the present disclosure can be implemented in the form of a system, a server, a mobile body, a control method, a program for implementing the control method, a non-transitory storage medium that stores the program, a program product, etc., for example. The program product may be provided as a storage medium that stores the program, or may be provided as a program product that can be distributed via a network, for example.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a configuration of a system according to a first embodiment;

FIG. 2 is a block diagram illustrating a configuration of a system according to the first embodiment;

FIG. 3 is a diagram illustrating a target region in the first embodiment;

FIG. 4 is a flowchart illustrating a processing procedure of travel control of a vehicle according to the first embodiment;

FIG. 5 is a flowchart illustrating a processing procedure of the command generation processing;

FIG. 6 is a diagram illustrating an example of matching according to the first embodiment;

FIG. 7 is a diagram for explaining an example of matching in the second embodiment;

FIG. 8 is a diagram illustrating an example of matching according to the third embodiment;

FIG. 9 is a diagram for explaining an example of matching in the fourth embodiment;

FIG. 10 is a diagram illustrating a target region in the fifth embodiment;

FIG. 11 is a block-diagram showing a configuration of a system according to a sixth embodiment; and

FIG. 12 is a flowchart illustrating a processing procedure of travel control of the vehicle according to the sixth embodiment.

### DETAILED DESCRIPTION OF EMBODIMENTS

### A. First Embodiment

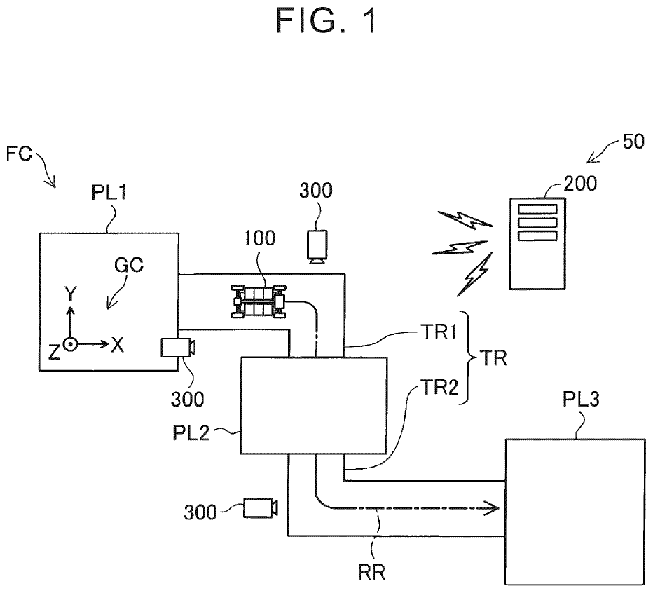

FIG. 1 is a conceptual diagram illustrating a configuration of a system 50 according to a first embodiment. The system 50 includes one or more vehicles 100, a server 200, and one or more distance measurement devices 300. The server 200 in the first embodiment corresponds to an “apparatus” in the present disclosure.

In the present disclosure, “moving object” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV: Battery Electric Vehicle), gasoline-powered vehicles, hybrid electric vehicle, and fuel cell electric vehicle. When the moving body is other than the vehicle, the expressions of “vehicle” and “vehicle” in the present disclosure can be appropriately replaced with “moving body”, and the expression of “traveling” can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

In the present disclosure, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Also, “autonomous control” includes “fully autonomous control” in which the vehicle 100 autonomously controls its operation without receiving any information from a device external to the vehicle 100. “Autonomous control” includes “partial autonomous control” in which the vehicle 100 autonomously controls its operation using information received from a device external to the vehicle 100.

The vehicle 100 may be provided with a configuration that can be moved by unmanned driving, and may be, for example, in the form of a platform having a configuration described below. Specifically, the vehicle 100 may include at least a vehicle control device and an actuator group, which will be described later, in order to perform three functions of “running,” “turning,” and “stopping” by unmanned driving. When information is acquired from a device outside the vehicle 100 for unmanned driving, the vehicle 100 may further include a communication device. That is, the vehicle 100 that can be moved by the unmanned driving may not be equipped with at least a part of an interior component such as a driver's seat or a dashboard. In addition, the vehicle 100 that can be moved by unmanned driving may not be equipped with at least a part of an exterior component such as a bumper or a fender. In addition, the vehicle 100 that can be moved by unmanned driving may not be equipped with the body shell. In this case, the remaining components, such as the body shell, may be mounted to the vehicle 100. Further, while the remaining components such as the body shell are not attached to the vehicle 100 until the vehicle 100 is shipped from the factory FC, the remaining components such as the body shell may be attached to the vehicle 100 after the vehicle 100 is shipped from the factory FC. Each of the components may be mounted from any direction, such as the upper side, lower side, front side, rear side, right side, or left side of the vehicle 100, each may be mounted from the same direction, or may be mounted from a different direction.

In the present embodiment, the system 50 is used in a factory FC that manufactures the vehicles 100. The reference coordinate system of the factory FC is a global coordinate system GC, and any position in the factory FC can be represented by the coordinates of X, Y, Z in the global coordinate system GC. The factory FC includes a first location PL1, a second location PL2, and a third location PL3. The first location PL1, the second location PL2, and the third location PL3 are connected by a track TR on which the vehicles 100 can travel. The track TR includes a first track TR1 connecting the first location PL1 and the second location PL2, and a second track TR2 connecting the second location PL2 and the third location PL3. A plurality of distance measurement devices 300 are installed in the factory FC along the track TR. The positions of the distance measurement devices 300 in the factory FC are adjusted in advance. Vehicles 100 travel from a first location PL1 to a third location PL3 through respective track TR and a second location PL2 by unmanned driving. In the present embodiment, the vehicles 100 are in the form of platforms while moving from the first location PL1 to the third location PL3.

In the first location PL1, the first track TR1, the second location PL2, the second track TR2, and the third location PL3, different processes are performed for the vehicles 100. In the first location PL1, a platform assembly process is performed to assemble the vehicles 100 to the form of a platform. In the first track TR1, a first moving step of moving the vehicles 100 to the second location PL2 by unmanned driving is performed. In the second location PL2, an assembling process of newly assembling components to the vehicles 100 is performed. In the second track TR2, a second moving step of moving the vehicles 100 to the third location PL3 by unmanned driving is performed. In the third location PL3, an inspection process of inspecting the vehicles 100 is performed. Note that the first moving step and the second moving step can also be said to be steps of transporting the vehicle 100 by the unmanned driving of the vehicle 100. The above-described steps are included in the manufacturing process of the vehicles 100 in the factory FC.

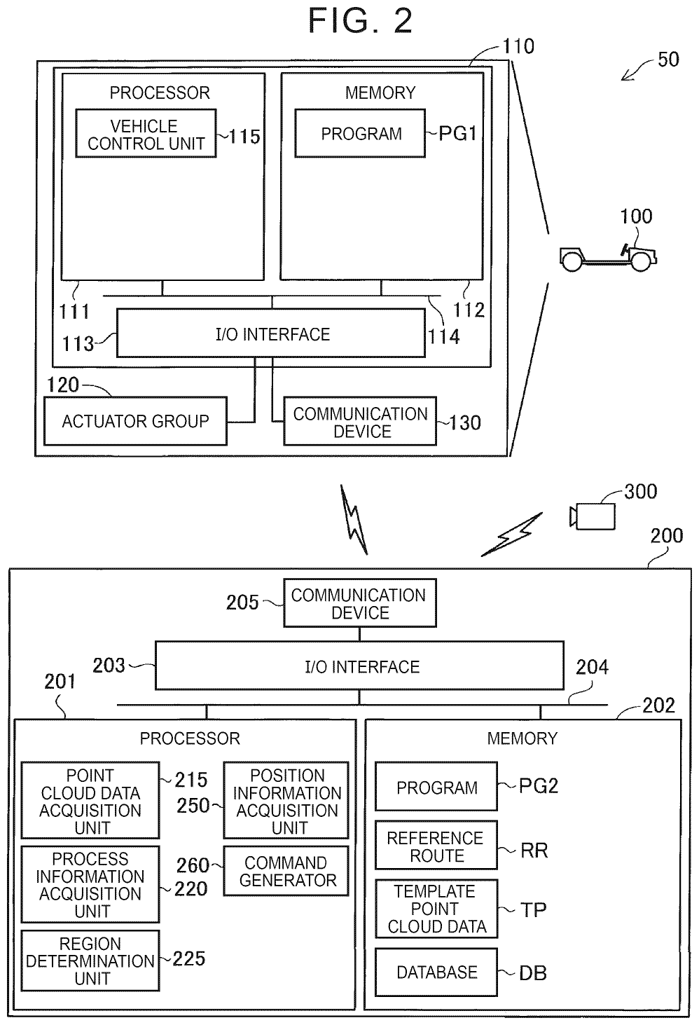

FIG. 2 is a block diagram illustrating a configuration of the system 50. The vehicle 100 includes a vehicle control device 110 for controlling each unit of the vehicle 100. The vehicle 100 includes an actuator group 120 including one or more actuators driven under the control of the vehicle control device 110. The vehicle 100 includes a communication device 130 for wirelessly communicating with an external device such as the server 200. The actuator group 120 includes an actuator of a driving device for accelerating the vehicle 100. The actuator group 120 includes an actuator of a steering device for changing a traveling direction of the vehicle 100. The actuator group 120 includes an actuator of a braking device for decelerating the vehicle 100. As described above, the actuator group 120 includes an actuator related to the travel of the vehicle 100. The driving device includes a battery, a traveling motor driven by electric power of the battery, and driving wheels rotated by the traveling motor. The actuator of the drive device includes a traveling motor.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The distance measurement device 300 corresponds to an external sensor that is a sensor located outside the vehicle 100. The distance measurement device 300 measures the vehicle 100 and outputs three-dimensional point cloud data as a detection result. As the distance measurement device 300, a camera or a light detection and ranging (LiDAR) can be used. In particular, LiDAR is preferable in that high-precision three-dimensional point cloud data can be obtained. The distance measurement device 300 according to the present embodiment is constituted by a LiDAR. In the present embodiment, the position of each distance measurement device 300 is fixed, and the relation between the global coordinate system GC and the device coordinate system of each distance measurement device 300 is known. Coordinate transformation matrices for converting the coordinate values of the global coordinate system GC and the coordinate values of the device coordinate system of the individual distance measurement devices 300 to each other are stored in advance in the server 200. The distance measurement device 300 includes a communication device (not shown), and can communicate with other devices such as the server 200 by wired communication or wireless communication. Hereinafter, the three-dimensional point cloud data measured by the distance measurement device 300 is also referred to as measurement point cloud data.

The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each distance measurement device 300 by wired communication or wireless communication. The memory 202 stores various types of information including a program PG2, a reference route RR, template point cloud data TP, and area database DB. The processor 201 executes the program PG2 stored in the memory 202 to realize various functions including a function of executing travel control of the vehicle 100, which will be described later, and a function as the point cloud data acquisition unit 215, the process information acquisition unit 220, the region determination unit 225, the position information acquisition unit 250, and the command generation unit 260.

The point cloud data acquisition unit 215 acquires the target point cloud data. The target point cloud data is three-dimensional point cloud data based on the measurement point cloud data, and is compared with the reference point cloud data by the position information acquisition unit 250 as described later. The reference-point cloud data is three-dimensional point cloud data based on a template point cloud data TP prepared in advance, and is compared with the target point cloud data by the position information acquisition unit 250.

The template point cloud data TP may be generated, for example, based on three-dimensional CAD data representing the appearance-shape of the vehicle 100, or may be generated by the vehicle 100 being measured in advance by the distance measurement device. The template point cloud data TP is preferably prepared according to, for example, a vehicle type or a model type. In this way, the reference point cloud data corresponding to the vehicle type and the type of the vehicle 100 can be used for comparison with the target point cloud data. In other embodiments, the template point cloud data TP may be stored in, for example, a computer or a recording medium external to the server 200.

The target point cloud data includes at least a point cloud of the target region. The reference point cloud data includes at least a point cloud corresponding to the target region. The target region is a region having at least an unassembled region. The target region in the present embodiment has only a non-assembled region. The non-assembled area is an area in which the components are not assembled to the vehicle 100 in a target process including a plurality of predetermined processes among the external shapes of the vehicle 100. The non-assembled area in the present embodiment is an area in which the components are not assembled to the vehicle 100 during the period from the platform assembly process to the inspection process, that is, during the period in which the vehicle 100 moves from the first location PL1 to the third location PL3 illustrated in FIG. 1.

In other embodiments, the region of interest may comprise a different region than the unassembled region. However, the ratio of the area of the non-assembled region to the target region is preferably 50% or more, more preferably 70% or more, and even more preferably 90% or more.

Hereinafter, a region of the outer shape of the vehicle 100 that is different from the non-assembled region is also referred to as an assembled region. The outline of the vehicle 100 in the assembly region varies greatly as compared to the outline of the vehicle 100 in the non-assembly region due to the assembly of components to the vehicle 100. More specifically, typically, the contour of the vehicle 100 in the unassembled region varies little or no change, while the contour of the vehicle 100 in the assembled region varies depending on the shape of the part being assembled.

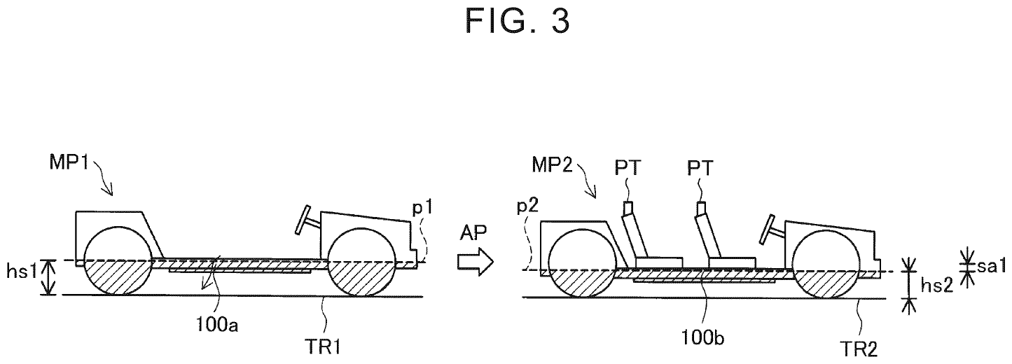

FIG. 3 is a diagram for explaining a target region in the present embodiment. FIG. 3 shows a vehicle 100a traveling on the first track TR1 and a vehicle 100b traveling on the second track TR2. In FIG. 3, the target region is hatched. The vehicle 100b corresponds to a vehicle 100a on which the component PT is assembled. The component PT is assembled to the assembly area of the vehicles 100 in the assembling process AP. The first moving process MP1 is performed on the vehicle 100a. The second moving process MP2 is performed on the vehicle 100b. When the first moving process MP1 is the first step, the assembling process AP and the second moving process MP2 correspond to the second step which is a post-step of the first step.

The target region in the present embodiment is defined as a region of the outer shape of the vehicle 100 that is equal to or smaller than a predetermined reference height. In the present disclosure, the reference height is defined as the height from the ground position of the vehicle 100 with respect to the horizontal plane in a state where the vehicle 100 is in contact with the horizontal plane. The reference height corresponds to a height from the ground plane in a state where the vehicle 100 is in contact with the horizontal plane. As shown in FIG. 3, the first reference height hs1 in the first moving process MP1 is higher than the second reference height hs2 in the second moving process MP2. In FIG. 3, the target region in the first moving process MP1 is an area located below the position p1 in the first reference height hs1 in the outer shape of the vehicle 100a. The target region in the second moving process MP2 is an area located below the position p2 in the second reference height hs2 in the outer shape of the vehicle 100b.

The reference height is preferably determined in accordance with the amount of subduction of the vehicle body of the vehicle 100 due to the assembly of the component with respect to the vehicle 100. For example, FIG. 3 shows a state in which the vehicle body of the vehicle 100 is subducted by the subduction amount sa1 in the vertical direction by assembling the component PT to the vehicle 100 AP the assembling process. The second reference height hs2 may be determined, for example, based on the first reference height hs1 and the sinking amount sa1. Further, the sinking amount sa1 may be calculated based on, for example, an experimental result or a simulated result.

As in the present embodiment, in a case where the target region is defined as a region having a reference height or less, the target region may include the entire region from the ground position to the reference height position in the height direction among the external shapes of the vehicle 100, or may include only a part of the region in the height direction. For example, the target region may be defined as a region having a height equal to or less than a reference height and greater than or equal to a predetermined height of zero. By determining the target region in this way, it is possible to suppress the influence of the road surface from reaching the target point cloud data, and it is possible to perform the comparison more appropriately between the target point cloud data and the reference point cloud data. In addition, it is preferable that the target region includes at least a part of an outer shape of a portion of the vehicle 100 having a larger feature amount 100. The feature amount is, for example, an edge amount. The portion having a large feature amount is, for example, a tire, a wheel, a bumper, or a frame. As described above, since the outline of the more characteristic portion is included in the target region, the comparison between the target point cloud data and the reference point cloud data can be more appropriately performed.

The description is returned to FIG. 2. The process information acquisition unit 220 acquires process information of the vehicle 100. The process information is information capable of specifying a process performed on the vehicle 100. As the process information, for example, information indicating which process the vehicle 100 is in may be used, or position information of the vehicle 100 may be used. Information indicating which process the vehicle 100 is in is acquired based on, for example, log data in which the progress status of each process is recorded or a work process. The log data and the work process may be stored in the memory 202 or may be stored in a computer or a recording medium outside the server 200 or the vehicle 100, for example. Further, as in the present embodiment, when the installation position of the distance measurement device 300 in the factory FC is predetermined, for example, the identification information of the distance measurement device 300 in charge of measuring the vehicles 100 and the information indicating the installation position of the distance measurement device 300 may be used as the process information.

The region determination unit 225 determines a target region. The region determination unit 225 in the present embodiment determines the target region using the process information acquired by the process information acquisition unit 220. Specifically, the region determination unit 225 determines the target region by referring to the area database DB based on the process data. In the area database DB, a plurality of process data and a plurality of area data are stored in association with each other. The process data is data representing a process performed on the vehicle 100. The area data is data representing a target region. The area data is expressed as, for example, coordinates for designating an area in the point cloud data such as the measurement point cloud data and the template point cloud data TP. The area data in the present embodiment is expressed as coordinates for designating a reference height in the measurement point cloud data or the template point cloud data TP.

The position information acquisition unit 250 acquires the position information of the vehicles 100 by comparing the target point cloud data based on the measurement point cloud data with the reference point cloud data based on the template point cloud data TP. The position information obtained in this way includes at least one of the position and the direction of the vehicle 100. Specifically, the position information acquisition unit 250 acquires vehicle position information to be described later by executing template matching between the target point cloud data and the reference point cloud data. Hereinafter, the template matching between the target point cloud data and the reference point cloud data is also simply referred to as matching. As the algorithm of the matching, various algorithms such as iterative closest point (ICP), normal distributions transform (NDT) can be used.

As will be described later, in the matching in the present embodiment, the point cloud data of the target region is used as the target point cloud data. The “point cloud data of the target region” includes a point cloud of the target region, and does not include a point cloud outside the target region in the outline of the vehicle 100. Further, in the matching in the present embodiment, the point cloud data corresponding to the target region is used as the reference point cloud data. The “point cloud data corresponding to the target region” includes a point cloud corresponding to the target region, and does not include a point cloud corresponding to a region outside the target region in the outline of the vehicle 100. Note that the measurement point cloud data in the present embodiment includes a point cloud of a target region and a point cloud of a region outside the target region among the external shapes of the vehicle 100. In addition, the template point cloud data TP according to the present embodiment includes a point cloud corresponding to the target region and a point cloud corresponding to an area outside the target region among the outlines of the vehicles 100.

The command generation unit 260 generates a control command for causing the vehicle 100 to travel by unmanned driving using the acquired vehicle position information, and transmits the control command to the vehicle 100. Specifically, the control command in the present embodiment is the above-described travel control signal. The control command for causing the vehicle 100 to travel by the unmanned driving may include at least one of a travel control signal and generation information for generating a travel control signal. Accordingly, in other embodiments, the control command may include generated information in place of or in addition to the travel control signal. As the generation information, for example, vehicle position information, a route and a target position, which will be described later, can be used.

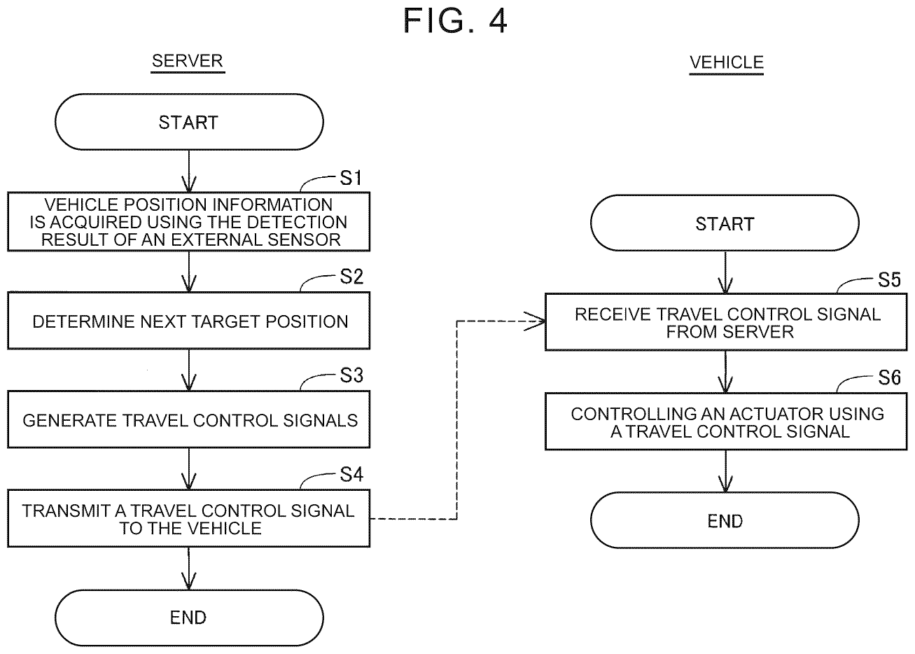

FIG. 4 is a flowchart illustrating a processing procedure of travel control of the vehicle 100 according to the first embodiment.

In S1, the processor 201 of the server 200 acquires the vehicle position information using the detection result outputted from the distance measurement device 300 which is an external sensor. The vehicle position information is position information that is a basis for generating a travel control signal. In the present embodiment, the vehicle position information includes the position and orientation of the vehicle 100 in the global coordinate system GC of the factory FC. Specifically, in S1, the processor 201 acquires vehicle-position data using the target point cloud data and the reference-point cloud data.

In S2, the processor 201 of the server 200 determines the target location to which the vehicles 100 should be heading next. In the present embodiment, the target position is represented by the coordinates of X, Y, Z in the global coordinate system GC. In the memory 202 of the server 200, reference route RR that is a route on which the vehicles 100 should travel is stored in advance. The route is represented by a node indicating a starting point, a node indicating a passing point, a node indicating a destination, and a link connecting the respective nodes. The processor 201 uses the vehicle position information and the reference route RR to determine the target position to which the vehicle 100 is to be directed next. The processor 201 determines the target position on the reference route RR ahead of the current position of the vehicles 100.

In S3, the processor 201 of the server 200 generates a travel control signal for causing the vehicle 100 to travel toward the determined target position. The processor 201 obtains the traveling speed from the vehicle 100, and compares the obtained traveling speed with the target speed. The processor 201 generally determines the acceleration so that the vehicle 100 accelerates when the travel speed is lower than the target speed, and determines the acceleration so that the vehicle 100 decelerates when the travel speed is higher than the target speed. Further, the processor 201 determines the steering angle and the acceleration so that the vehicle 100 does not deviate from the reference route RR when the vehicle 100 is located on the reference route RR, and determines the steering angle and the acceleration so that the vehicle 100 returns to the reference route RR when the vehicle 100 is not located on the reference route RR, in other words, when the vehicle 100 deviates from the reference route RR.

In S4, the processor 201 of the server 200 transmits the generated travel control signal to the vehicles 100. The processor 201 repeats acquisition of vehicle position information, determination of a target position, generation of a travel control signal, transmission of a travel control signal, and the like at predetermined intervals.

In S1 to S4 in the present embodiment, specifically, a command generation process to be described later is executed.

In S5, the processor 111 of the vehicle 100 receives the travel control signal transmitted from the server 200. In S6, the processor 111 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the system 50 of the present embodiment, the vehicle 100 can be driven by remote control, and the vehicle 100 can be moved without using a conveyance facility such as a crane or a conveyor.

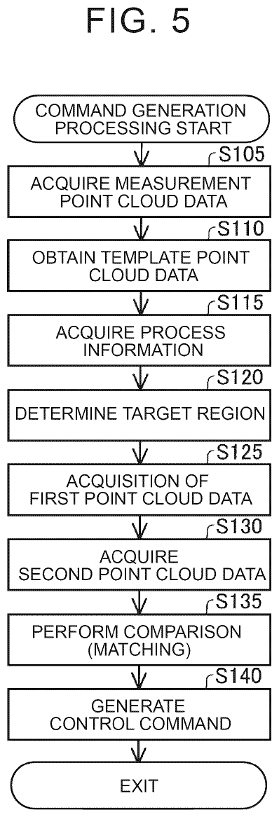

FIG. 5 is a flowchart illustrating a processing procedure of the command generation processing according to the present embodiment. The command generation processing illustrated in FIG. 5 is executed by the processor 201 of the server 200 at predetermined time intervals, for example.

In S105, the point cloud data acquisition unit 215 acquires the measurement point cloud data from the distance measurement device 300 in charge of measurement of the target vehicle 100. The target vehicle 100 is the vehicle 100 that is a target of travel control by unmanned driving. In S110, the point cloud data acquisition unit 215 acquires the template point cloud data TP stored in the memory 202. In another embodiment, the point cloud data acquisition unit 215 may acquire the template point cloud data TP from, for example, an external computer or a recording medium in S110.

In S115, the process information acquisition unit 220 acquires process information of the target vehicles 100. In S120, the region determination unit 225 determines the target region using the process data and the area database DB.

In S125, the position information acquisition unit 250 acquires the first point cloud data, which is the point cloud data of the target region, as the target point cloud data by excluding a part of the measurement point cloud data acquired by S105 based on the target region determined by S120. The first point cloud data corresponds to point cloud data including a point cloud of a target region among the measurement point cloud data and not including a point cloud of a region outside the target region. Specifically, in S125, the point cloud data acquisition unit 215 acquires the first point cloud data by, for example, extracting a point cloud of the target region from the measurement point cloud data based on the determined target region, or deleting a point cloud of the region outside the target region from the measurement point cloud data. Area data in the area database DB may be used to extract or delete such point clouds.

In S130, the position information acquisition unit 250 acquires the second point cloud data corresponding to the target region as the reference point cloud data by excluding a part of the template point cloud data TP acquired by S110 based on the target region determined by S115. The second point cloud data corresponds to point cloud data including a point cloud corresponding to the target region and not including a point cloud corresponding to an area outside the target region in the template point cloud data TP. In S130, the point cloud data acquisition unit 215 acquires the second point cloud data by, for example, extracting a point cloud corresponding to the target region from the template point cloud data TP based on the determined target region, or deleting a point cloud of an area outside the target region from the template point cloud data TP, substantially in the same manner as S125.

In S135, the position information acquisition unit 250 acquires the vehicle position information of the target vehicle 100 by executing matching between the target point cloud data and the reference point cloud data. Specifically, in S135 according to the present embodiment, the position information acquisition unit 250 acquires the vehicle position information of the target vehicle 100 by executing matching between the first point cloud data acquired by S125 and the second point cloud data acquired by S130.

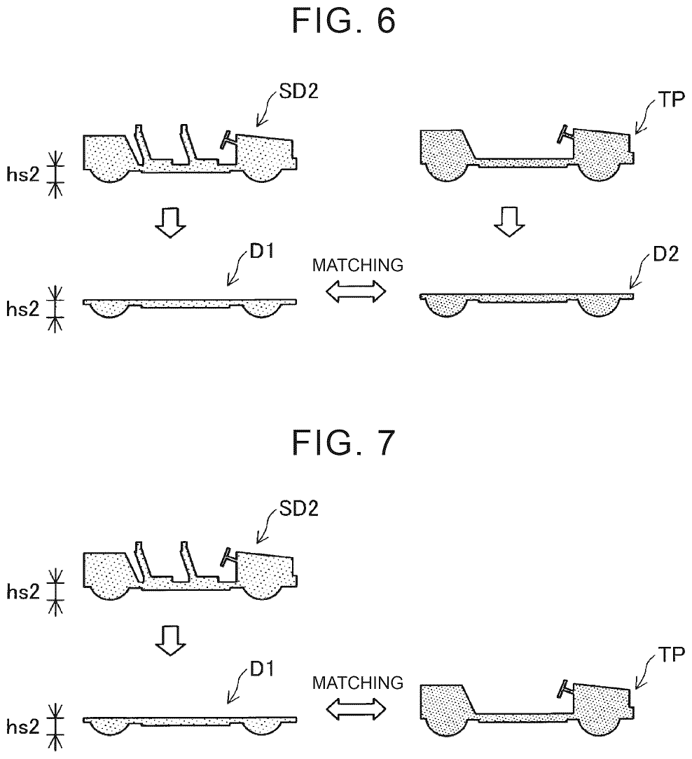

FIG. 6 is a diagram for explaining an example of matching in the present embodiment. Specifically, FIG. 6 shows an exemplary matching performed in the second moving process MP2. FIG. 6 illustrates a state in which the first point cloud data D1 as the target point cloud data is generated by excluding a part of the point cloud from the measurement point cloud data SD2 measured in the second moving process MP2. FIG. 6 shows a state in which the second point cloud data D2 as the reference-point cloud data is generated by excluding a part of the point cloud from the template point cloud data TP. In FIG. 6, in S135, the first point cloud data D1 and the second point cloud data D2 are matched to obtain vehicle position data of the target vehicle 100.

In S140, the command generation unit 260 generates a travel control signal as a control command by using the vehicle position information acquired by S135, and transmits the travel control signal to the vehicle 100. The vehicle control unit 115 controls the actuator group 120 by using the received control command, thereby causing the vehicle 100 to travel.

According to the server 200 in the present embodiment described above, the vehicle position information is acquired by comparing the target point cloud data including the point cloud of the target region having the unassembled region with the reference point cloud data including the point cloud corresponding to the target region. Therefore, since the matching according to the target region can be performed, even when the external shape of the vehicle 100 changes with the assembly of the component to the vehicle 100, the comparison between the target point cloud data and the reference point cloud data can be appropriately performed, and the vehicle position information can be appropriately acquired.

Further, in the present embodiment, the target region is a region equal to or smaller than the reference height among the external shapes of the vehicles 100, and the first reference height hs1 in the first moving process MP1 is higher than the second reference height hs2 in the second moving process MP2. According to this aspect, the second reference height hs2 can be made lower than the first reference height hs1 in accordance with the sinking of the vehicle body of the vehicle 100 caused by the assembly of the components to the vehicle 100 by the assembling process AP. Therefore, the matching can be performed more appropriately.

Further, in the present embodiment, the first point cloud data, which is the point cloud data of the target region, is used as the target point cloud data. Therefore, the matching can be performed more appropriately as compared with the case where the target point cloud data including the point cloud of the region outside the target region is used for the matching.

Further, in the present embodiment, the first point cloud data is point cloud data in which a part of the measurement point cloud data measured by the distance measurement device 300 is excluded. Therefore, even when the measurement point cloud data includes a point cloud of a region outside the target region, the point cloud data of the target region can be used for matching as the target point cloud data, and matching can be performed more appropriately.

In another embodiment, in a case where the point cloud data in which a part of the measurement point cloud data is excluded is used as the target point cloud data, the target point cloud data may include a point cloud of a region outside the target region among the outlines of the vehicle 100. In this case, it is preferable that the target point cloud data is acquired by excluding a part of the point cloud of the region outside the target region from the measurement point cloud data. In this way, for example, the matching can be performed more appropriately as compared with the case where the measurement point cloud data is directly used for the matching as the target point cloud data.

Further, in the present embodiment, the second point cloud data, which is the point cloud data corresponding to the target region, is used as the reference point cloud data. Therefore, the matching can be performed more appropriately as compared with the case where the reference point cloud data including the point cloud corresponding to the region outside the target region is used for the matching. In particular, in the present embodiment, since the first point cloud data and the second point cloud data are compared in the matching, the matching can be performed more appropriately.

In the present embodiment, the second point cloud data is point cloud data in which a part of the template point cloud data TP is excluded. Therefore, even when the template point cloud data TP includes a point cloud corresponding to an area outside the target region, the point cloud data corresponding to the target region can be used for matching as reference point cloud data, and matching can be performed more appropriately. Further, in the present embodiment, it is possible to use the point cloud data corresponding to the target region as the reference point cloud data while reducing the time and effort for preparing the template point cloud data corresponding to the target region in advance.

In another embodiment, when the point cloud data in which a part of the template point cloud data TP is excluded is used as the reference point cloud data, the reference point cloud data may include a point cloud corresponding to an area outside the target region in the outline of the vehicle 100. In this case, it is preferable that part of the point cloud corresponding to the region outside the target region is excluded from the template point cloud data TP, so that the point cloud data for referencing is acquired. In this way, for example, the matching can be performed more appropriately than when the template point cloud data TP is used as the reference point cloud data for matching as it is.

### B. Second Embodiment

FIG. 7 is a diagram for explaining an example of matching in the second embodiment. FIG. 7 shows an exemplary matching in the second moving process MP2 in the same manner as FIG. 6. In the second embodiment, unlike the first embodiment, in the matching, not the second point cloud data D2 but the template point cloud data TP including the point cloud corresponding to the area outside the target region is used as it is as the reference point cloud data. Specifically, as shown in FIG. 7, in the matching, the first point cloud data D1 and the template point cloud data TP are compared. In the second embodiment, S130 of the steps illustrated in FIG. 5 may be omitted. Among the configurations of the system 50 and the server 200 in the second embodiment, portions not specifically described are the same as those in the first embodiment.

Since the server 200 according to the second embodiment described above can also perform the matching according to the target region, even when the external shape of the vehicle 100 changes with the assembly of the component to the vehicle 100, the comparison between the target point cloud data and the reference point cloud data can be appropriately performed, and the vehicle position information can be appropriately acquired. In particular, in the present embodiment, in the matching, since the template point cloud data TP is used as it is instead of the second point cloud data D2 as the reference point cloud data, the matching can be performed more easily.

### C. Third Embodiment

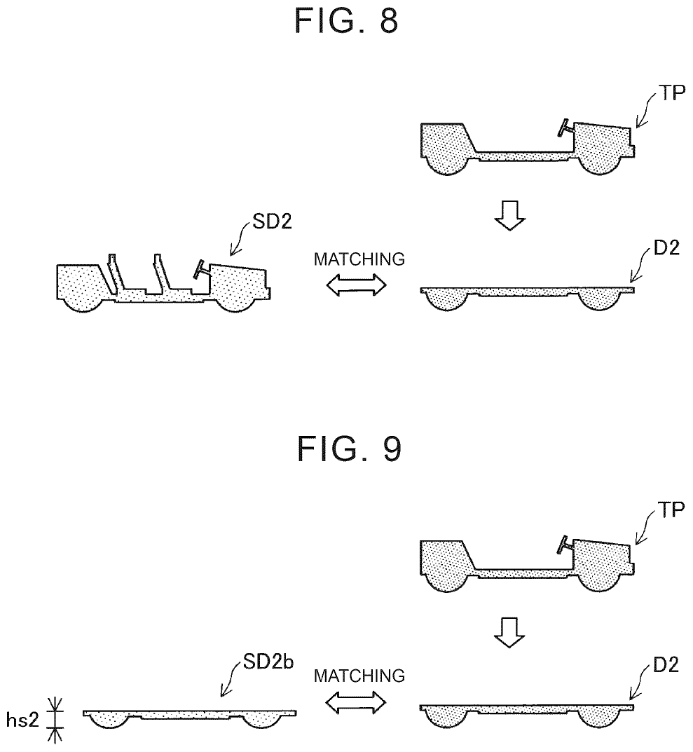

FIG. 8 is a diagram for explaining an example of matching in the third embodiment. FIG. 8 shows an exemplary matching performed in the second moving process MP2, similar to FIG. 6. In the third embodiment, unlike the first embodiment, in the matching, not the first point cloud data D1 but the measurement point cloud data SD2 including the point cloud of the area outside the target region is used as it is in the matching. Specifically, as shown in FIG. 8, in the matching, the measurement point cloud data SD2 and the second point cloud data D2 are compared. In the third embodiment, S125 of the steps illustrated in FIG. 5 may be omitted. Among the configurations of the system 50 and the server 200 in the third embodiment, portions not specifically described are the same as those in the first embodiment.

Since the server 200 according to the third embodiment described above can also perform the matching according to the target region, even when the external shape of the vehicle 100 changes with the assembly of the component to the vehicle 100, the target point cloud data and the reference point cloud data can be appropriately compared with each other, and the vehicle position information can be appropriately acquired. In particular, in the present embodiment, in the matching, the measurement point cloud data is used as it is instead of the first point cloud data D1 as the target point cloud data, so that the matching can be performed more easily.

### D. Fourth Embodiment

FIG. 9 is a diagram for explaining an example of matching in the fourth embodiment. FIG. 9 shows an exemplary matching performed in the second moving process MP2, similar to FIG. 6. In the fourth embodiment, unlike the first embodiment, the measurement point cloud data SD2b is used as the target point cloud data in the matching. Specifically, as shown in FIG. 8, in the matching, the measurement point cloud data SD2b and the second point cloud data D2 are compared. Among the configurations of the system 50 and the server 200 in the fourth embodiment, portions not specifically described are the same as those in the first embodiment.

The measurement point cloud data SD2b is point cloud data of the target region, unlike the measurement point cloud data SD2 in the first embodiment. In the present embodiment, the distance measurement devices 300 are arranged so as to be able to measure the measurement point cloud including only the point cloud data of the target region in the factory FC. Specifically, the distance measurement devices 300 in the present embodiment are arranged at a lower position or a position closer to the track TR than in the first embodiment, for example. In the fourth embodiment, S125 of the steps illustrated in FIG. 5 may be omitted.

Since the server 200 according to the fourth embodiment described above can also perform the matching according to the target region, even when the external shape of the vehicle 100 changes with the assembly of the component to the vehicle 100, the comparison between the target point cloud data and the reference point cloud data can be appropriately performed, and the vehicle position information can be appropriately acquired. In particular, in the present embodiment, in the matching, the measurement point cloud data SD2b which is the point cloud data of the target region can be used as the target point cloud data. Therefore, the matching can be performed more easily and more appropriately.

In other embodiments, the measurement point cloud data SD2b and the template point cloud data TP may be compared in the matching. In this embodiment, S115, S120, and S130 may be omitted in addition to S125 among the steps illustrated in FIG. 5. Further, in this embodiment, the system 50 may not include the process information acquisition unit 220 or the region determination unit 225.

### E. Fifth Embodiment

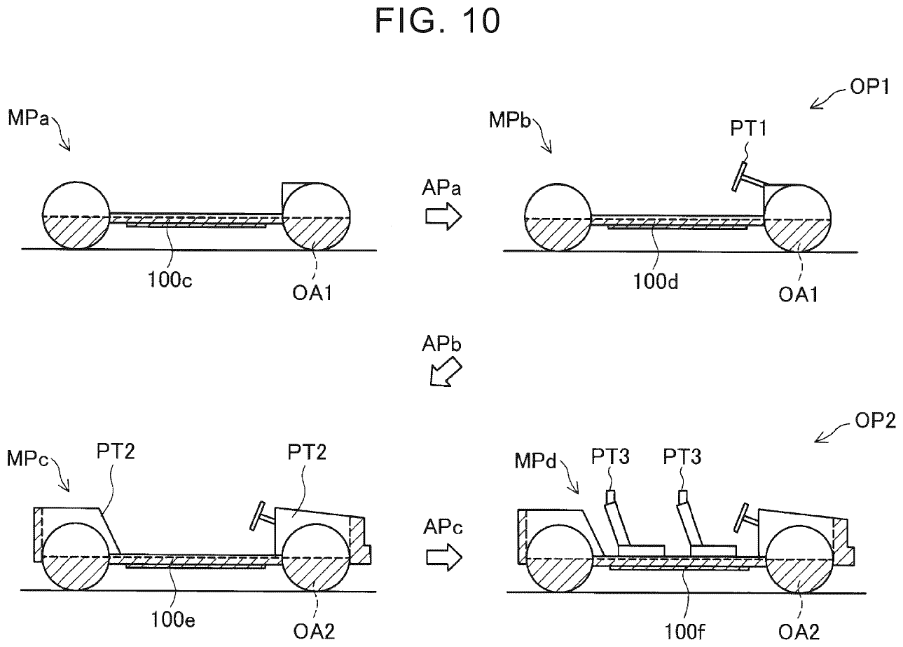

FIG. 10 is a diagram illustrating a target region in the fifth embodiment. In the present embodiment, the first target region OA1 related to the first target process OP1 and the second target region OA2 related to the second target process OP2 are used as target regions. In FIG. 10, the first target region OA1 and the second target region OA2 are indicated by dashed lines and hatched lines, respectively. Among the configurations of the system 50 and the server 200 in the fifth embodiment, portions not specifically described are the same as those in the first embodiment.

The first target process OP1 includes a moving process MPa, MPb and an assembling process APa, APb. The second target process OP2 includes a moving process MPc, MPd and an assembling process APc. As illustrated in FIG. 10, in the manufacturing process of the vehicles 100, the respective processes are performed in the order of the moving process MPa, the assembling process APa, the moving process MPb, the assembling process APb, the moving process MPc, the assembling process APc, and the moving process MPd. The moving process MPa is a step of moving the vehicle 100c by unmanned driving. The assembling process APa is a step of assembling the component PT1 to the vehicle 100c. The moving process MPb is a step of moving the vehicle 100d by unmanned driving. The vehicle 100d corresponds to a vehicle 100c on which the component PT1 is assembled. The assembling process APb is a step of assembling the component PT2 to the vehicle 100d. The moving process MPc is a step of moving the vehicle 100e by unmanned driving. The vehicle 100e corresponds to a vehicle 100d on which the component PT2 is assembled. The moving process MPd is a step of moving the vehicle 100f by unmanned driving. The vehicle 100f corresponds to a vehicle 100e on which the component PT3 is assembled.

In the moving process MPa, the moving process MPb, the assembling process APa, and the assembling process APb included in the first target process OP1, the target point cloud data including the point cloud of the first target region OA1 is matched with the reference point cloud data including the point cloud corresponding to the first target region OA1. In addition, in the moving process MPc, the moving process MPd, and the assembling process APc included in the second target process OP2, the target point cloud data including the point cloud of the second target region OA2 is matched with the reference point cloud data including the point cloud corresponding to the second target region OA2. In the present embodiment, the first target region OA1 includes only the non-assembled region in the first target process OP1. The second target region OA2 includes only a non-assembled region in the second target process OP2. In addition, the second target region OA2 in the present embodiment is a region larger than the first target region OA1. Specifically, the second target region OA2 includes, in addition to the same region as the first target region OA1, a part of the outer shape of the component PT2 assembled by the assembling process APb. In this way, a plurality of target regions may be used in the factory FC.

In the present embodiment, matching of the aspects described in the first to fourth embodiments can be performed. In other embodiments, the second target region OA2 may not include the same region as the first target region OA1, or may include only a part of the same region as the first target region OA1. In other embodiments, the size of the second target region OA2 may be the same as the size of the first target region OA1 or may be smaller than the size of the first target region OA1. In addition, three or more target regions may be used in the factory FC.

Since the server 200 according to the present embodiment described above can also perform the matching according to the target region, even when the external shape of the vehicle 100 changes with the assembly of the component to the vehicle 100, the comparison between the target point cloud data and the reference point cloud data can be appropriately performed, and the vehicle position information can be appropriately acquired. In particular, in the present embodiment, a plurality of target regions is used in the factory FC. According to this aspect, the target region can be changed in accordance with the progress of the manufacturing process of the vehicle 100, specifically, in accordance with the assembly of the components to the vehicle 100. In this case, for example, after the process of assembling a component having a large feature amount with respect to the vehicle 100 is performed, matching is performed using a region including at least a part of the external shape of the component as a target region, whereby the possibility of performing matching more appropriately can be increased. In this case, for example, in the target step after the step of assembling the bumper or the step of assembling the frame, the matching is performed using, as the target region, a region including at least a part of the outer shape of the assembled bumper or frame, whereby the possibility of performing the matching more appropriately can be increased. As described above, by changing the target region according to the progress of the manufacturing process of the vehicle 100, the matching can be performed more appropriately in each process.

### F. Sixth Embodiment

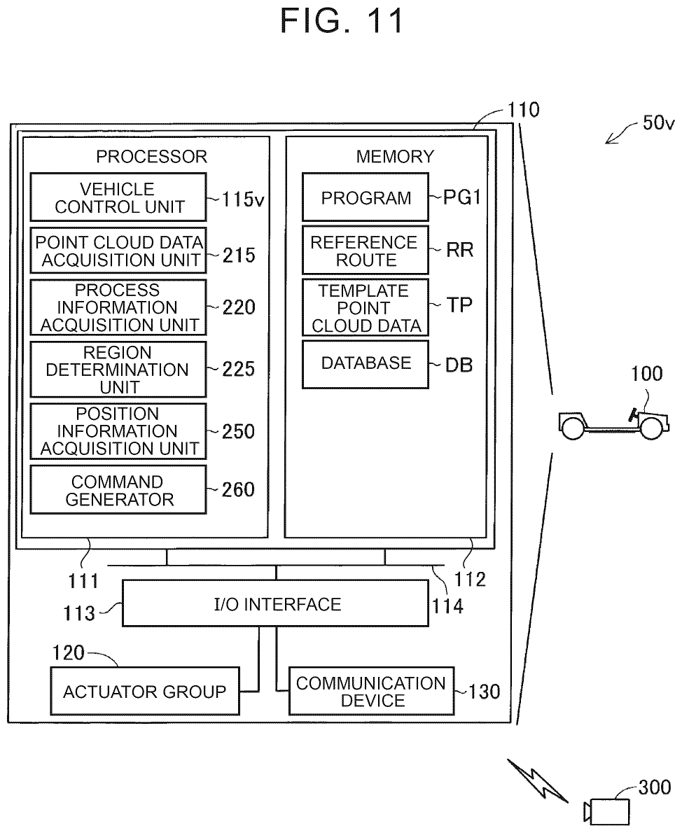

FIG. 11 is a diagram illustrating a configuration of a system 50v according to a sixth embodiment. Unlike the first embodiment, the system 50v of the present embodiment does not include the server 200. Further, the vehicle according to the present embodiment can travel by autonomous control of the vehicle. Since the apparatus configuration of the vehicle in the present embodiment is the same as that of the vehicle 100 in the first embodiment, the vehicle in the present embodiment is also referred to as the vehicle 100 for convenience. Among the configurations of the system 50v and the vehicles 100 in the sixth embodiment, parts not specifically described are the same as those in the first embodiment.

In the present embodiment, the communication device 130 of the vehicle 100 can communicate with the distance measurement device 300. The processor 111 of the vehicle control device 110 executes the program PG2 stored in the memory 112 to function as the vehicle control unit 115v, the point cloud data acquisition unit 215, the process information acquisition unit 220, the region determination unit 225, and the position information acquisition unit 250. The vehicle control unit 115v controls the actuator group 120 by using the travel control signal generated by the vehicle 100, so that the vehicle 100 can travel by autonomous control. In addition to the program PG1, the memory 112 stores a reference route RR, template point cloud data TP, and area database DB. The vehicle control device 110 according to the sixth embodiment corresponds to a “device” according to the present disclosure.

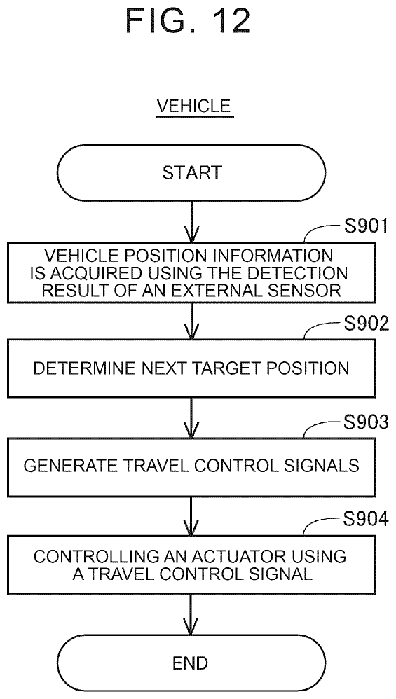

FIG. 12 is a flowchart illustrating a processing procedure of travel control of the vehicle 100 according to the sixth embodiment. In S901, the processor 111 of the vehicle 100 acquires the vehicle position information using the detection result outputted from the distance measurement device 300 which is an external sensor. In S902, the processor 111 determines a target position to which the vehicles 100 should be heading next. In S903, the processor 111 generates a travel control signal for causing the vehicles 100 to travel toward the determined target position. In S904, the processor 111 controls the actuator of the vehicle 100 by using the generated travel control signal, thereby causing the vehicle 100 to travel in accordance with the parameter represented by the travel control signal. The processor 111 repeats acquisition of vehicle position information, determination of a target position, generation of a travel control signal, and control of an actuator at a predetermined cycle. According to the system 50v of the present embodiment, the vehicle 100 can be caused to travel by autonomous control of the vehicle 100 without remotely controlling the vehicle 100 by the server 200.

In S904 from S901 in the present embodiment, the same command generation process as in FIG. 5 is executed. The command generation processing is executed by the processor 111 of the vehicle control device 110 at predetermined time intervals, for example. In the present embodiment, the target vehicle means the host vehicle.

In the present embodiment, the steps in FIG. 5 are executed by the processor 111. In S140 according to the present embodiment, the command generation unit 260 of the vehicle 100 generates and outputs a travel control signal as a control command using the vehicle position information acquired by S135. The vehicle control unit 115v controls the actuator group 120 by using the control command generated by the vehicle 100 in this way, thereby causing the vehicle 100 to travel.

Since the vehicle control device 110 according to the present embodiment described above can also execute the matching according to the target region, even when the external shape of the vehicle 100 changes with the assembly of the components to the vehicle 100, the target point cloud data and the reference point cloud data can be appropriately compared with each other, and the vehicle position information can be appropriately acquired.

Note that, in a mode in which the vehicle 100 travels by autonomous control as in the present embodiment, for example, matching may be performed in the same manner as in the second to sixth embodiments. In addition, in a mode in which the vehicles 100 travel by autonomous control, the measurement point cloud data SD2b and the template point cloud data TP may be compared by matching. In this instance, S115, S120, S125, and S130 of the steps illustrated in FIG. 5 may be omitted. In this case, the vehicle 100 may not include the process information acquisition unit 220 or the region determination unit 225. Further, in a mode in which the vehicle 100 travels by autonomous control, for example, the system 50 may be provided with the server 200.

### G. Other Embodiments

(G1) In each of the above-described embodiments, the position information acquired by the position information acquisition unit 250 includes the position and the direction of the vehicle 100, but may include only one of the position and the direction of the vehicle 100.

(G2) In each of the above embodiments, template point cloud data as point cloud data corresponding to the target region may be prepared in advance, and the prepared template point cloud data may be used as reference point cloud data. In this way, as in the case where the second point cloud data is used as the reference point cloud data, the matching can be performed more appropriately as compared with the case where the reference point cloud data including the point cloud corresponding to the region outside the target region is used for the matching. Here, S130 of FIG. 5 may be omitted.

(G3) In each of the above-described embodiments, in the system 50, various functional units such as the point cloud data acquisition unit 215, the process information acquisition unit 220, the region determination unit 225, the position information acquisition unit 250, and the command generation unit 260 may be provided in the vehicle 100. In this case, as described in the sixth embodiment, all of the point cloud data acquisition unit 215, the process information acquisition unit 220, the region determination unit 225, the position information acquisition unit 250, and the command generation unit 260 may be provided in the vehicle 100, or a part of these functional units may be provided in the vehicle 100. In the system 50, some or all of these functional units may be provided in a device outside the server 200 and the vehicle 100.

(G4) In the first embodiment, the server 200 executes processing from acquisition of vehicle position information to generation of a travel control signal. On the other hand, at least a part of the processing from the acquisition of the vehicle position information to the generation of the travel control signal may be executed by the vehicle 100. For example, the following forms (1) to (3) may be used.

(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a travel control signal so that the vehicle 100 travels on the route received from the server 200, and control the actuator of the vehicle 100 using the generated travel control signal.

(2) The server 200 may acquire the vehicle position information and transmit the acquired vehicle position information to the vehicle 100. The vehicle 100 may determine a target position to which the vehicle 100 should be directed next, generate a route from the current position of the vehicle 100 represented in the received vehicle position information to the target position, generate a travel control signal so that the vehicle 100 travels on the generated route, and control the actuator of the vehicle 100 using the generated travel control signal.

(3) In the above embodiments (1) and (2), an internal sensor may be mounted on the vehicle 100, and a detection result output from the internal sensor may be used for at least one of generation of a route and generation of a travel control signal. The internal sensor is a sensor mounted on the vehicle 100. Specifically, the inner sensor may include, for example, a camera, a LiDAR, a millimeter-wave radar, an ultrasonic sensor, a GPS sensor, an accelerometer, a gyroscope, and the like. For example, in the embodiment (1), the server 200 may acquire the detection result of the internal sensor and reflect the detection result of the internal sensor in the path when generating the path. In the aspect (1), the vehicle 100 may acquire the detection result of the internal sensor and reflect the detection result of the internal sensor in the travel control signal when generating the travel control signal. In the aspect (2), the vehicle 100 may acquire the detection result of the internal sensor and reflect the detection result of the internal sensor in the path when generating the path. In the aspect (2), the vehicle 100 may acquire the detection result of the internal sensor and reflect the detection result of the internal sensor in the travel control signal when generating the travel control signal.

(G5) In the sixth embodiment, an internal sensor may be mounted in the vehicle 100, and a detection result output from the internal sensor may be used for at least one of generation of a route and generation of a travel control signal. For example, the vehicle 100 may acquire the detection result of the internal sensor and reflect the detection result of the internal sensor on the route when generating the route. The vehicle 100 may acquire the detection result of the internal sensor and reflect the detection result of the internal sensor in the travel control signal when generating the travel control signal.

(G6) In the first embodiment, the server 200 automatically generates a travel control signal to be transmitted to the vehicle 100. On the other hand, the server 200 may generate a travel control signal to be transmitted to the vehicle 100 in accordance with an operation of an external operator located outside the vehicle 100. For example, an external operator may operate a control device including a display for displaying a captured image output from an external sensor, a steering for remotely controlling the vehicle 100, an accelerator pedal, a brake pedal, and a communication device for communicating with the server 200 through wired communication or wireless communication, and the server 200 may generate a travel control signal corresponding to an operation applied to the control device. Hereinafter, the driving of the vehicle 100 under such control is also referred to as “remote manual driving”. In the mode in which the remote manual driving is executed, for example, the vehicle position information acquired by the position information acquisition unit 250 may be displayed on a display included in the control device. In this case, the vehicle position information may be represented by, for example, characters or symbols on a display, or may be represented on a map.

(G7) The vehicle 100 may be manufactured by combining a plurality of modules. The module means a unit composed of a plurality of components arranged in accordance with a part or a function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the components constituting the platform, the components constituting a part of the vehicle 100 different from the platform may be modularized. Further, the various modules may include any exterior parts such as bumpers and grills, and any interior parts such as sheets and consoles. In addition, not only the vehicle 100 but also a moving object of an arbitrary mode may be manufactured by combining a plurality of modules. Such a module may be manufactured, for example, by joining a plurality of parts by welding, a fixture, or the like, or may be manufactured by integrally molding at least a part of the parts constituting the module as one part by casting. Molding techniques for integrally molding one part, in particular a relatively large part, are also called gigacasts or megacasts. For example, the front module, the central module, and the rear module described above may be manufactured using gigacast.

(G8) Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled production, for example, at least a part of conveyance of the vehicle 100 is realized by self-propelled conveyance in a factory that manufactures the vehicle 100.

(G9) In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to each of the above embodiments, and can be realized by various configurations without departing from the spirit thereof. For example, the technical features in the embodiments corresponding to the technical features in the respective embodiments described in the Summary can be appropriately replaced or combined in order to solve some or all of the above-described problems or to achieve some or all of the above-described effects. Further, when the technical features are not described as essential in the present specification, these can be deleted as appropriate.

What is claimed is:

1. An apparatus comprising:
a point cloud data acquisition unit that acquires three-dimensional point cloud data including a point cloud of a target region having a region in which a component is not assembled in a plurality of predetermined processes, of an outer shape of a mobile body; and
a position information acquisition unit that acquires at least one of a position and a direction of the mobile body by comparing the acquired three-dimensional point cloud data with reference point cloud data including a point cloud corresponding to the target region.

2. The apparatus according to claim 1, wherein:
the target region is a region with a predetermined reference height or less, of an outer shape of a vehicle as the mobile body; and
the reference height in a first process is higher than the reference height in a second process as a post process of the first process.

3. The apparatus according to claim 1, wherein the three-dimensional point cloud data is point cloud data of the target region.

4. The apparatus according to claim 3, wherein the three-dimensional point cloud data is point cloud data obtained by removing a part of measurement point cloud data measured by a distance measurement device.

5. The apparatus according to claim 1, wherein the reference point cloud data is point cloud data corresponding to the target region.
